(19) United States
(12) Patent Application Publication
(10) Pub. No.: US 2019/0253757 A1
(43) Pub. Date: Aug. 15, 2019

(54) SYSTEMS AND METHODS FOR BLOCKING SPOILERS

(71) Applicant: Rovi Guides, Inc., San Jose, CA (US)

(72) Inventor: Roger Anthony Leister, Downington, PA (US)

(21) Appl. No.: 15/892,565

(22) Filed: Feb. 9, 2018

(51) Int. Cl. H04N 21/454; H04N 21/488; H04N 21/45; H04N 21/431; H04N 21/44

(52) U.S. Cl. CPC H04N 21/4542; H04N 21/4886; H04N 21/44008; H04N 21/4318; H04N 21/4532

(57) ABSTRACT

Systems and methods are disclosed herein for providing an anti-spoiler block based on analyzing content of spoiler information and determining whether the spoiler information is to be blocked. For example, the media guidance application may monitor user actions and content of scrolling news within each video frame that is to be displayed to determine whether a visual element, e.g., a “grey blocker” is to be overlaid upon the scrolling news such that spoiler information in the scrolling news will not be visible. In this way, the user is protected from spoiler information and thus the user viewing experience has improved.

### BACKGROUND

Existing media systems conventionally display a scrolling news banner in synchronization with a media asset when the media asset is being transmitted. For example, a news ticker or scrolling banner may provide information relating to sporting event news, entertainment news, finance news, promotional information of another media asset, weather alerts, amber alerts, and/or the like. Sometimes the scrolling news may include spoiler information to a user. For example, the scrolling news may include the latest competition result of a sporting event that the user has not watched yet. Unexpected exposure to the spoiler information may render the user viewing experience unsatisfactory. In another example, sometimes the scrolling news may include information relevant to the user's daily life, such as an emergent weather alert, and/or the like. Neglecting such emergent weather alert may lead to inconvenience or even risk of life safety of the user.

Some existing media systems prevent a user to access segments that contain spoiler information in a media asset (e.g., a segment that shows the final score of a sporting game) during a fast-access playback operation. Other existing systems monitor and remove web content such as social media posts, or web news that contain spoiler information. In these systems, a client component receives web content in a structured format, e.g., a social media post, a message, RSS feeds, etc., and thus the client component is able to remove the spoiler message or feeds and generate a web layout without the spoiler information. When a media asset including news tickers is received as streaming media data of video frames from a media source, e.g., a television channel, it becomes difficult and impractical to remove news tickers that are already embedded in video frames generated by the media source and generate video frames without the news tickers for display at the user equipment.

### SUMMARY

Accordingly, systems and methods are disclosed herein for providing an anti-spoiler block based on analyzing content of spoiler information and determining whether the spoiler information is to be blocked. For example, the media guidance application may monitor user actions and content of scrolling news within each video frame that is to be displayed to determine whether a visual element, e.g., a “grey blocker” is to be overlaid upon the scrolling news such that spoiler information in the scrolling news will not be visible. In this way, the user is protected from spoiler information and thus the user viewing experience has improved.

The media guidance application may receive a media asset including a plurality of consecutive video frames for display at the user equipment. For example, the media guidance application may receive a live tennis match transmitted from a linear media source. Prior to displaying each of the plurality of consecutive video frames from the media asset, the media guidance application may determine whether extra information additional to content of a respective video frame will be simultaneously displayed at the user equipment with the respective video frame.

In some embodiments, the media guidance application may first identify a media source corresponding to the media asset based on metadata associated with the media asset. For example, the media guidance application may parse the metadata received with the media asset to identify a data field that contains the identifier of the media source. The media guidance application may then retrieve, from a video frame format database, a video frame template corresponding to the media source.

In some embodiments, the media guidance application may then identify an area within the video frame template that is used for displaying extra information additional to the content of the media asset, for example, based on the coordinates of the scrolling news banner defined in the data structure of the video frame template data. The media guidance application may determine whether an information object is displayed at a same area within the respective video frame with the identified area within the video frame template.

In some embodiments, the media guidance may then determine whether the information object contains extra information. In response to determining that the information object is displayed at the same area within the respective video frame with the identified area within the video frame template, the media guidance application may perform character recognition on the information object to extract text. For example, the media guidance application may extract text of “latest news,” “Federer makes to Final,” etc. The media guidance application may then compare the extracted text with metadata associated with the media asset to generate a difference metric.

In some embodiments, in response to determining that the difference metric is higher than a difference threshold, the media guidance application may determine that the information object within the respective video frame contains extra information additional to content of the media asset. In response to determining that the extra information will be simultaneously displayed with the respective video frame, the media guidance application may identify a key term from the extra information. For example, the media guidance application may obtain key terms such as “latest news,” “Federer,” “Final,” from the text. The media guidance application may then query a spoiler relevance table, based on the key term to determine a spoiler metric indicative of a degree of spoiler information that the extra information contains.

For example, the media guidance application may transmit a query comprising the key term to the spoiler relevance table storing a plurality of keywords. In response to receiving a matching keyword from the spoiler relevance table identified for the key term, the media guidance application may retrieve a first numeric value corresponding to the matching keyword from the spoiler relevance table as the spoiler metric for the extra information. In response to receiving no matching keyword from the spoiler relevance table identified for the key term, the media guidance application may extract a different key term from the extra information to conduct the query. Or the media guidance application may obtain a closest keyword from the spoiler relevance table based on the transmitted query, and retrieve a second numeric value corresponding to the closest keyword from the spoiler relevance table as the spoiler metric for the extra information.

The media guidance application may then compare the determined spoiler metric with a pre-defined spoiler threshold. In response to determining that the spoiler metric is greater than the pre-defined spoiler threshold, the media guidance application may determine an event relating to the spoiler information based on the spoiler information. For example, the media guidance application may identify the event from the spoiler information, e.g., “US Open Men's Final 2017.”

In some embodiments, the media guidance application may parse the one or more obtained data artifacts to identify information of the event relating to the spoiler information. For example, the information of the event may include an event name, an event start date, an event end date, an event sponsor name, an event type, an event schedule, an event roster, and a competition result of the event, and/or the like. The media guidance application may then query user activity history based on information relating to the event for a plurality of information artifacts indicative of user interactions with the event.

For example, the media guidance application may access a user profile storing user activity history including user interactive activities with a plurality of data sources. The media guidance application may then determine a query term from the extra information. The media guidance application may then query the retrieved user activity history based on the query term, and obtain a plurality of information artifacts containing the query term from the user activity history. For example, the artifacts may indicate that the user has clicked “like” on social media on a news link reporting the player “Federer” made it to the final game in men's single.

The media guidance application may determine a blocking metric based on a comparison of the spoiler information relating to the event and the plurality of information artifacts. For example, for each information artifact from the plurality of information artifacts, the media guidance application may determine a user preference indication for or against the query term based on content of a respective information artifact. The media guidance may then assign a respective cruciality level associated with the query term to each of the plurality of information artifacts based on the user preference indication and the content of the respective information artifact and content. For example, the artifact indicating that the user has subscribed to the channel of the player “Federer” on social media may be assigned to a relatively high cruciality score. The media guidance application may then compute a normalized sum of all cruciality levels corresponding to the plurality of information artifacts as the blocking metric.

In response to determining that the blocking metric is greater than the pre-defined blocking threshold, the media guidance application may generate for display the respective video frame and the extra information with an overlay of a visual element on top of an area where the extra information is displayed to cover the extra information

In some embodiments, the media guidance application may determine, from the extra information and by text recognition, a first text displayed at a first area within the respective video frame and a second text at a second area within the respective video frame. For example, the text within the news banner may include the phrase “latest news” and the phrase “Federer made to Final.” The media guidance application may then determine that the first text includes the spoiler information and the second text does not include the spoiler information by querying the spoiler relevance table. The media guidance application may then configure the size and shape parameters of the visual element to have the visual element cover the first area and to prevent the visual element to cover the second area.

In some embodiments, prior to a respective video frame from the plurality of video frames being displayed, the media guidance application may receive, via communication circuitry, a user command to launch the overlay of the visual element on top of the area where the extra information is displayed. When a user input has been received, the media guidance application may optionally refrain from determining the spoiler metric or the blocking metric for every video frame of the media asset being played to reduce processing burden on the processing circuitry of the user equipment.

In some embodiments, in response to receiving the user command to manually turn on the visual blocker, the media guidance application may continue monitoring video frames and implement additional measure to evaluate whether the manual visual blocker should be placed so as not to block important information. For example, the media guidance application may retrieve a pre-defined whitelist of alert information that is pre-defined to be exempted from the overlay of the visual element. For example, the pre-defined whitelist may include keywords such as, but not limited to “alert,” “attack,” “weather,” “earthquake,” “storm,” “flood,” and/or the like. The media guidance application may determine whether the extra information contained in the respective video frame belongs to the pre-defined white list. In response to determining that the extra information contained in the respective video frame belongs to the pre-defined whitelist, the media guidance application may refrain from overlaying the visual element on top of the area where the extra information is displayed for the respective video frame.

In some embodiments, the media guidance application may retrieve, from a user profile, information relating to one or more user interested items, e.g., tennis, sports gears, Federer, US Open, etc. The media guidance application may query, an advertisement database based on information relating to the one or more user interested items. In response to obtaining an advertisement (e.g., a pre-stored advertisement or a winning bid from the Ad Exchange), the media guidance application may adapt the advertisement into a display advertisement having a size and a shape to cover the extra information, and overlay the display advertisement on top of the area where the extra information is displayed.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 depicts an illustrative example diagram for providing an anti-spoiler block with a media asset that is being played, in accordance with some embodiments of the disclosure;

FIG. 2 provides an example block diagram illustrating an unblocked scrolling news banner that is displaying weather alert information, according to an embodiment described herein;

FIG. 3 provides an example block diagram illustrating using a display advertisement as an anti-spoiler blocker, according to an embodiment described herein;

FIG. 4 shows an illustrative embodiment of a display screen that may be used to provide media guidance application listings and other media guidance information, in accordance with some embodiments of the disclosure;

FIG. 5 shows another illustrative embodiment of a display screen that may be used to provide media guidance application listings, in accordance with some embodiments of the disclosure;

FIG. 6 is a block diagram of an illustrative user equipment (UE) device in accordance with some embodiments of the disclosure;

FIG. 7 is a block diagram of an illustrative media system in accordance with some embodiments of the disclosure;

FIG. 8 depicts an illustrative flowchart of a process for detecting spoiler information displayed simultaneously with a media asset and providing a visual element to block display of the spoiler information, in accordance with some embodiments of the disclosure;

FIG. 9 depicts an illustrative flowchart of a process for detecting spoiler information displayed simultaneously with a media asset and providing a visual element to block display of the spoiler information, in accordance with some embodiments of the disclosure;

FIG. 10 depicts an illustrative flowchart of a process for querying a spoiler relevance table based on the key term to determine a spoiler metric indicative of a degree of spoiler information that the extra information contains, in accordance with some embodiments of the disclosure;

FIG. 11 depicts an illustrative flowchart of a process for querying of the user activity history based on information relating to the event for a plurality of information artifacts indicative of user interactions with the event, in accordance with some embodiments of the disclosure;

FIG. 12 depicts an illustrative flowchart of a process for generating for display of the respective video frame and the extra information with an overlay of a visual element on top of an area where the extra information is displayed to cover the extra information, in accordance with some embodiments of the disclosure; and

FIG. 13 depicts an illustrative flowchart of a process for processing anti-spoiler visual block with a pre-defined whitelist of items, in accordance with some embodiments of the disclosure.

### DETAILED DESCRIPTION

Systems and methods are disclosed herein for blocking spoilers during the display of a media asset. Specifically, a media guidance application, implemented at user equipment, may be used to analyze content of spoiler information from each video frame of a media asset and determine whether the spoiler information is to be blocked. For example, the media guidance application may monitor user actions and content of scrolling news within each video frame that is to be displayed to determine whether a visual element, e.g., a “grey blocker” is to be overlaid upon the scrolling news such that spoiler information in the scrolling news will not be visible.

In some embodiments, a score-based system may be used to determine whether the media guidance application should turn on the spoiler block. For example, the score-based system may weigh factors relating to the content of the scrolling news, e.g., sports news having the latest competition result of a sporting event is more likely to be spoiler than weather alerts. For another example, the score-based system may weigh factors relating to user interactions with a topic or an event, e.g., if the user's social media activities indicate the user has already been exposed to the latest competition result of a sporting event, the scrolling news including the competition result does not constitute “spoiler” to the user. Therefore, the media guidance application intelligently analyzes user interactions with topics of news event and provides a visual element over a display of a media asset to block visibility of an area of the display accordingly. In this way, the user is protected from spoiler information and thus the user viewing experience has improved. In the meantime, the intelligent analysis performed by the media guidance application obviates excessive blocking when an anti-spoiler block is unnecessary, and thus the efficiency of video processing (e.g., overlaying additional visual element on video frames to cover the scrolling news section) at the user equipment can be improved.

As referred to herein, the term “extra information” refers to any audio, video or textual information that is not part of the content of a media asset. Specifically, extra information may refer to supplemental information that is not part of video frames of the originally created media asset but is received from another source and is then combined with the video frames of the media asset. For example, when a live tennis match is being transmitted from a media source such as the ESPN channel, the ESPN channel may receive sports news updates and then overlay the sports news updates as a scrolling news banner onto video frames of the live tennis match, indicating a result of another tennis match. The scrolling news banner thus constitutes “extra information” to the live tennis match being played. For another example, extra information may include any information such as social media feeds, email messages, mobile messages, web news, and/or the like that are overlaid onto the display of the media asset. In some embodiments, the media guidance application may overlay such social media feeds, email messages, mobile messages, web news relating to a user profile onto video frames of a media asset.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in VOD systems), Internet content (e.g., streaming content, downloadable content, Webcasts, etc.), video clips, audio, content information, pictures, rotating images, documents, playlists, websites, articles, books, electronic books, blogs, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer-readable media. Computer-readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

It is to be noted that embodiments described herein may be implemented by a media guidance application implemented on a set-top box, or any other application that receives media guidance data and that can be configured to remotely communicate with a set-top box.

With the advent of the Internet, mobile computing, and high-speed wireless networks, users are accessing media on user equipment devices on which they traditionally did not use. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters” or providers” logos, etc.), media format (e.g., standard definition, high definition, 3D, etc.), on-demand information, blogs, websites, and any other type of guidance data that is helpful for a user to navigate among and locate desired content selections.

As referred to herein, the term “in response to” refers to initiated as a result of. For example, a first action being performed in response to a second action may include interstitial steps between the first action and the second action. As referred to herein, the term “directly in response to” refers to caused by. For example, a first action being performed directly in response to a second action may not include interstitial steps between the first action and the second action.

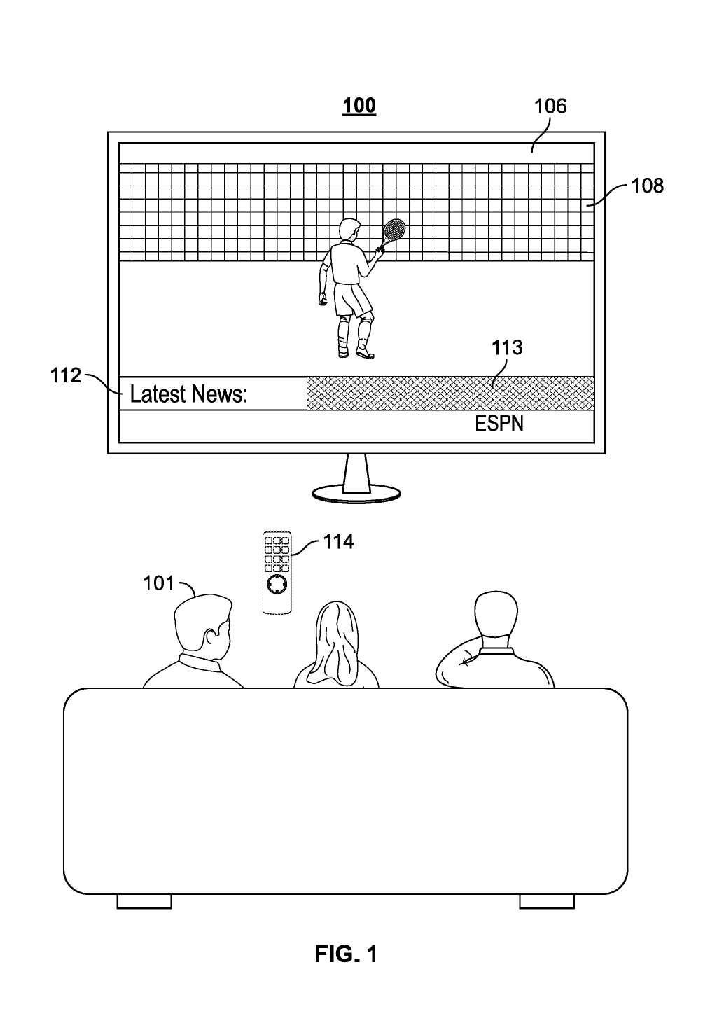

FIG. 1 depicts an illustrative example diagram 100 for providing an anti-spoiler block with a media asset that is being played, in accordance with some embodiments of the disclosure. Diagram 100 shows user equipment 106 displaying a media asset 108, and a display screen of the media asset 108 on the user equipment shows a scrolling banner 112. For example, the media asset 108 may relate to a live sporting event (e.g., a tennis match) that is transmitted from a sports channel (e.g., the EPSN channel). For another example, the media asset 108 may be a previously stored media asset stored at a digital video recorder (DVR). The media asset 108, while being played, may include an information banner 112 being displayed at the same time with the media asset 108. The information banner 112 may contain news information, weather alerts, security alerts, and/or the like.

Diagram 100 further shows a user 101 operating a user device 114. For example, the user device 114 may include a remote control of the user equipment. For another example, the user device 114 may include a second screen device, such as a smartphone, a tablet computer, a laptop computer, and/or the like, which implements an application that allows the user device 114 to remotely communicate and control the playback of the media asset 108 at the user equipment 106.

The media guidance application, e.g., installed at the user equipment 106, may detect spoiler information displayed simultaneously with the media asset 108 and provide a visual element, e.g., a “grey” or otherwise shaded box 113, to block display of the spoiler information. Specifically, the media guidance application may receive a media asset (e.g., 108) including a plurality of consecutive video frames for display at the user equipment 106. For example, the media guidance application may receive a live tennis match transmitted from a linear media source (e.g., the EPSN channel). For another example, the media guidance application may receive the tennis match which is previously recorded at a DVR from the storage device of the DVR. In some embodiments, the media guidance application may receive the media asset 108 in an encoded digital format, and may then decode the encoded digital file in order to display each frame of the media asset 108 at the user equipment 106.

The media guidance application may determine whether a video frame to be displayed contains extra information that is not part of the content of the media asset. Specifically, prior to displaying each of the plurality of consecutive video frames from the media asset 108, the media guidance application may determine whether extra information additional to content of a respective video frame will be simultaneously displayed at the user equipment with the respective video frame. For example, the media guidance application may load the respective video frame at a buffer (e.g., at the user equipment) and perform image analysis on the video frame.

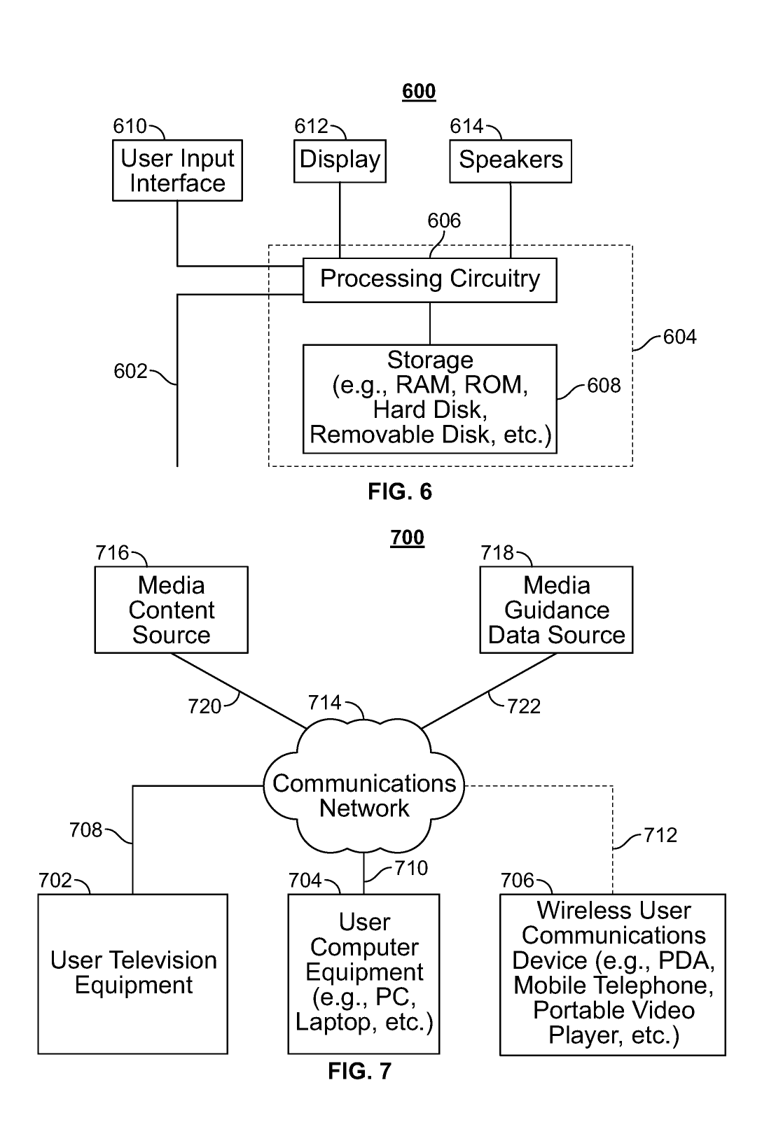

In some embodiments, to determine whether extra information additional to content of a respective video frame will be simultaneously displayed at the user equipment with the respective video frame, the media guidance application may first identify a media source corresponding to the media asset based on metadata associated with the media asset. For example, the media guidance application may parse the metadata received with the media asset 108 to identify a data field that contains the identifier of the media source (e.g., the ESPN channel). The media guidance application may then retrieve, from a video frame format database, a video frame template corresponding to the media source. For example, the media guidance application may transmit a query, to the video frame format databases (e.g., storage 608 in FIG. 6, or data source 718 accessible via communications network 714 in FIG. 7), based on the identifier of the media source, e.g., “ESPN.” The media guidance application may in turn obtain a video frame template corresponding to a display layout format of media assets transmitted from the ESPN channel, which indicates the position, the shape and the type of extra information displayed within a video frame, e.g., a scrolling news banner 112.

In some embodiments, the media guidance application may then identify an area within the video frame template that is used for displaying extra information additional to the content of the media asset, e.g., based on the coordinates of the scrolling news banner 112 defined in the data structure of the video frame template data. The media guidance application may determine whether an information object is displayed at a same area within the respective video frame with the identified area within the video frame template. For example, the media guidance application may determine, via edge detection, whether an object having a dimension similar to a defined object such as a news banner defined in the video frame template, is displayed within the video frame at the coordinates defined in the video frame template.

In some embodiments, the media guidance may then determine whether the information object contains extra information. For example, in some implementations, the object displayed within the video frame at the position for a news banner as defined in the video frame template may not contain extra information, e.g., the object may be a bar displaying the current score of a sporting event that is being played. Thus, in response to determining that the information object is displayed at the same area within the respective video frame with the identified area within the video frame template, the media guidance application may perform character recognition on the information object to extract text. For example, as shown at the banner object 112, the media guidance application may extract text of “latest news,” “Federer makes to Final,” etc. The media guidance application may then compare the extracted text with metadata associated with the media asset 108 to generate a difference metric. For example, the metadata, such as a brief description, captioning data, etc., associated with the tennis match 108 may include “Kerber,” “Williams,” “deuce,” and/or the like. By comparing the metadata with the extracted text, the difference metric, e.g., the non-overlapping percentage, may be relatively high, as the extracted text from the banner object 112 indicates different player names from the player names indicated in the metadata of the tennis match 108.

In some embodiments, in response to determining that the difference metric is higher than a difference threshold, the media guidance application may determine that the information object within the respective video frame contains extra information additional to content of the media asset. For example, when the non-overlapping percentage between the extracted text from the object 112 and the metadata of the media asset 108 is higher than 50%, 60%, or another pre-defined percentage, the object 112 may be deemed to contain extra information, e.g., “latest news” about “Federer” when the media asset 108 relates to “women's single final” between “Kerber” and “Williams.” In another example, when the non-overlapping percentage between the extracted text from the object 112 and the metadata of the media asset 108 is relatively low, the object 112 may not be deemed as containing extra information—e.g., when object 112 contains text such as “Williams,” “Kerber,” “1^{st},” “2^{nd},” etc., while the media asset 108 relates to “women's single final” between “Kerber” and “Williams,” the object 112 may be a score display box accompanying the tennis match 108.

The media guidance application may continue to determine whether the extra information constitutes spoiler information to the user. Specifically, in response to determining that the extra information will be simultaneously displayed with the respective video frame, the media guidance application may identify a key term from the extra information. For example, when the media guidance application performs character recognition on the information object 112, the media guidance application may obtain key terms such as “latest news,” “Federer,” “Final,” from the text within the object 112. The media guidance application may then query a spoiler relevance table, e.g., which is accessed from storage 608 in FIG. 6, or data source 718 accessible via communications network 714 in FIG. 7, based on the key term to determine a spoiler metric indicative of a degree of spoiler information that the extra information contains. For example, the spoiler relevance table includes a list of key terms, and a numeric spoiler metric for each key term on the list. The spoiler relevance table may take a form similar to the following:

TABLE 1
Example Spoiler Metric Table

| Key Term | Spoiler Metric |
|---|---|
| Final | 0.65 |
| Semi-Final | 0.65 |
| Oust | 0.56 |
| Last round | 0.55 |
| “Federer,” “Kerber,” . . . | 0.35 |
| Injured | 0.44 |
| . . . | . . . |

In some embodiments, the media guidance application may constantly, intermittently or periodically update the spoiler metric table. For example, the media guidance application may monitor web content, such as news articles, social media posts, and/or the like that the user has interacted with (e.g., leaving a comment, clicking “like,” etc.), and extract key terms from the web content and assign a spoiler metric to the key term based on the user's interaction with the key term. The media guidance application may then add the key term with the assigned spoiler metric to the spoiler metric table.

In some embodiments, the media guidance application may transmit a query comprising the key term (e.g., “Final,” “Federer,” etc.) to the spoiler relevance table storing a plurality of keywords, e.g., similar to Table 1. In response to receiving a matching keyword from the spoiler relevance table identified for the key term, e.g., the query term “Final” may match with an entry “Final” on the spoiler metric table, the media guidance application may retrieve a first numeric value (e.g., 0.65) corresponding to the matching keyword from the spoiler relevance table as the spoiler metric for the extra information. In response to receiving no matching keyword from the spoiler relevance table identified for the key term (e.g., “Federer,”), the media guidance application may extract a different key term from the extra information, such as “Final,” etc. to conduct the query. Or the media guidance application may obtain a closest keyword from the spoiler relevance table based on the transmitted query (e.g., “US Open Men's Final 2017,” etc.), and retrieve a second numeric value corresponding to the closest keyword (e.g., “Final”) from the spoiler relevance table as the spoiler metric for the extra information. In some implementations, the media guidance application may create a new entry in the spoiler relevant table to store the key term corresponding to the second numeric value, e.g., “US Open Men's Final 2017” with a spoiler metric of “0.65.”

The media guidance application may then compare the determined spoiler metric with a pre-defined spoiler threshold, e.g. 0.55, 0.45, etc. In response to determining that the spoiler metric is greater than the pre-defined spoiler threshold, the media guidance application may determine an event relating to the spoiler information based on the spoiler information. For example, in some implementations, the media guidance application may identify the event from the spoiler information directly, e.g., “US Open Men's Final 2017.” For another example, the media guidance application may transmit, to a data source of data artifacts (e.g., storage 608 in FIG. 6 or data source 718 accessible via communications network 714 in FIG. 7), a query based on the spoiler information, e.g., “Final,” “Federer,” etc. In response to the transmitted query, the media guidance application may obtain one or more data artifacts containing information that matches the spoiler information. For example, the media guidance application may obtain tennis events that Federer has made to the Final in the same year based on the query term “Final” and “Federer,” and then may restrict the search for the artifacts based on a time frame of the current time to limit the artifact to a current or a recent event of “US Open Men's Final 2017.”

The media guidance application may then determine whether a user's interest in the event, or whether the user has been exposed to the spoiler information already. Specifically, the media guidance application may parse the one or more obtained data artifacts to identify information of the event relating to the spoiler information. For example, the information of the event is selected from a group consisting of an event name, an event start date, an event end date, an event sponsor name, an event type, an event schedule, an event roster, and a competition result of the event, and/or the like. The media guidance application may then query user activity history based on information relating to the event for a plurality of information artifacts indicative of user interactions with the event.

For example, the media guidance application may access a user profile storing user activity history including user interactive activities with a plurality of data sources, e.g., user web browsing history, user viewing history of media assets, user social media activity history (e.g., subscription, following, likes, comments, etc.), and/or the like. In some implementations, the media guidance application may filter the user activity history within a time period, e.g., during the course of the identified event “US Open 2017,” and/or the like. The media guidance application may then determine a query term from the extra information. For example, the query term may be indicative of a participant in the event, e.g., “Federer.” The media guidance application may then query the retrieved user activity history based on the query term, and obtain a plurality of information artifacts containing the query term “Federer” from the user activity history. For example, the artifacts may indicate that the user has clicked “like” on social media on a news link reporting the player “Federer” made it to the final game in men's single, that the user has subscribed to the channel of the player “Federer” on social media, and/or the like. In another example, the artifact may indicate that the user has scheduled to record the men's single final game involving the player “Federer,” and a viewing status indicating whether the user has viewed the recorded men's single final game.

The media guidance application may then determine whether the spoiler information needs to be blocked from the user at the time when the video frame is to be displayed. Specifically, the media guidance application may determine a blocking metric based on a comparison of the spoiler information relating to the event and the plurality of information artifacts. For example, for each information artifact from the plurality of information artifacts, the media guidance application may determine a user preference indication for or against the query term based on content of a respective information artifact. For example, the media guidance application may determine that the user has a preference towards or is interested in knowing information relating to the query term “Federer” if the user has subscribed to the channel of “Federer” on social media. The media guidance may then assign a respective cruciality level associated with the query term to each of the plurality of information artifacts based on the user preference indication and the content of the respective information artifact and content. For example, the artifact indicating that the user has subscribed to the channel of the player “Federer” on social media may be assigned to a relatively high cruciality score. For another example, the artifact indicating that the user has scheduled to record the men's single final game involving the player “Federer” may be assigned a relatively high cruciality score. The media guidance application may then compute a normalized sum of all cruciality levels corresponding to the plurality of information artifacts as the blocking metric.

In some embodiments, in addition to the blocking metric computed based on a cruciality level of the spoiler information, the media guidance application may further keep track of the user's exposure to the spoiler information. Specifically, the media guidance application may monitor user awareness of the spoiler information via the plurality of information artifacts. For example, when one or more of the plurality of information artifacts indicate that the user has “liked” a news post relating to the spoiler information, or the user has watched at least a threshold percentage (e.g., 65%, 70% etc.) of a recorded media asset relating to the spoiler information, the media guidance application may determine that the user has already been exposed to the spoiler information. In this case, the media guidance application may reset the blocking metric to a low value so as not to trigger any anti-spoiler blocking.

To determine whether to trigger any anti-spoiler blocking, the media guidance application may compare the blocking metric with a pre-defined blocking threshold. Specifically, in response to determining that the blocking metric is greater than the pre-defined blocking threshold, the media guidance application may generate for display the respective video frame and the extra information with an overlay of a visual element on top of an area where the extra information is displayed to cover the extra information. For example, as shown at 113, the media guidance application may generate an opaque “grey” (or any other color) rectangular block 113 to cover the news banner 112 such that the extra information displayed within the news banner 112 is invisible to the user 101.

In some embodiments, the media guidance application may generate the anti-spoiler block to cover the entire news banner 112. In some embodiments, the media guidance application may only partially cover the news banner 112 such that only the spoiler content is invisible. Specifically, the media guidance application may determine, from the extra information and by text recognition, a first text displayed at a first area within the respective video frame and a second text at a second area within the respective video frame. For example, the text within the news banner 112 may include the phrases “latest news” and the phrase “Federer made to Final,” e.g., the phases may be displayed with different fonts, different font colors, different background colors, etc. The media guidance application may then determine that the first text includes the spoiler information and the second text does not include the spoiler information by querying the spoiler relevance table. For example, the media guidance application may determine that the phrase of “latest news” itself does not contain any spoiler information as such phase is not listed on the spoiler information table. For another example, for the phrase “Federer made to Final,” the media guidance application may identify that at least the keywords “Federer” or “Final” contains spoiler information as each of them corresponds to a keyword on the spoiler information table. The media guidance application may then configure the size and shape parameters of the visual element to have the visual element cover the first area and to prevent the visual element to cover the second area. For example, as shown at 112, the “grey” visual element 113 is configured to cover the portion displaying “Feder made it to Final,” while the text “latest news” is left unblocked. In this way, the text “latest news” is visible to the user 101 in order to provide the user the context of the blocking (e.g., information in the latest news constitutes spoiler to the user 101), as opposed to blindly blocking all content at the news banner 112.

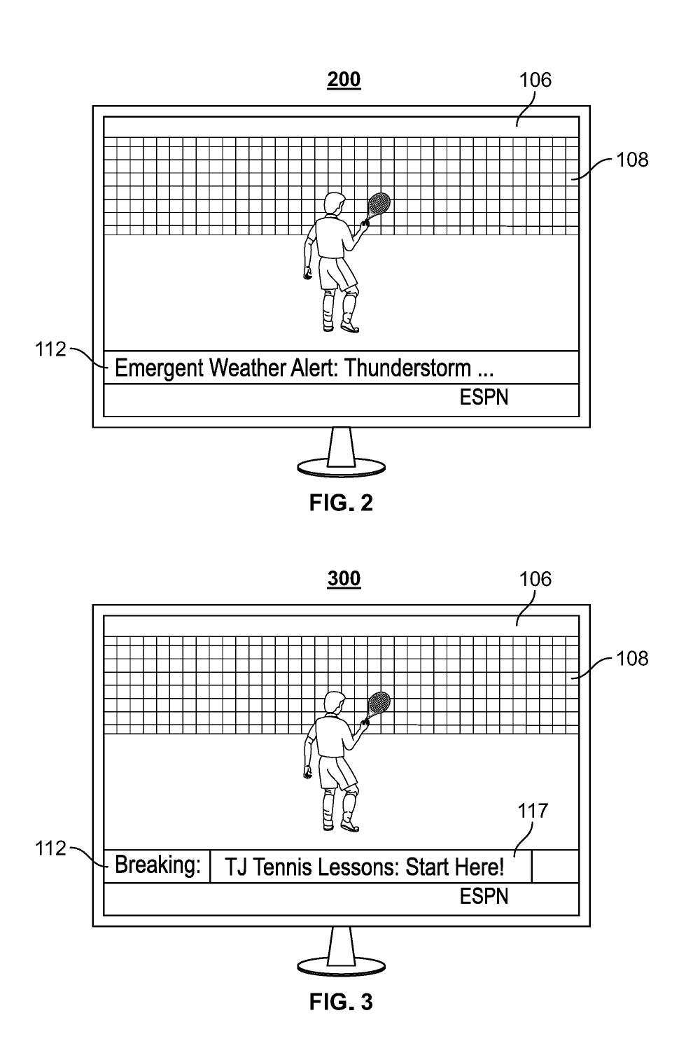

FIG. 2 provides an example block diagram 200 illustrating an unblocked scrolling news banner that is displaying weather alert information, according to an embodiment described herein. In some embodiments, the media guidance application may receive a user input to manually turn on the visual blocking function. Specifically, prior to a respective video frame from the plurality of video frames being displayed, the media guidance application may receive, via communication circuitry (e.g., see input/output path 602 in FIG. 6), a user command to launch the overlay of the visual element on top of the area where the extra information is displayed. For example, the user 101 may operate the user device 114 to manually request the visual blocker 113 be overlaid when the media asset 108 is being played. When a user input has been received, the media guidance application may refrain from determining the spoiler metric or the blocking metric for every video frame of the media asset being played to reduce processing burden on the processing circuitry of the user equipment 106.

In some embodiments, even if the user may have manually requested the visual blocker, the media guidance application may evaluate whether the visual block 113 should be implemented so as not to block crucial information that does not constitute spoiler information, e.g., weather alert, safety alert, etc. Specifically, in response to receiving the user command to turn on the visual blocker 113, the media guidance application may retrieve a pre-defined whitelist of alert information that is pre-defined to be exempted from the overlay of the visual element. For example, the pre-defined whitelist may include keywords such as, but not limited to “alert,” “attack,” “weather,” “earthquake,” “storm,” “flood,” and/or the like. The media guidance application may determine whether the extra information contained in the respective video frame belongs to the pre-defined white list. In response to determining that the extra information contained in the respective video frame belongs to the pre-defined white list, the media guidance application may refrain from overlaying the visual element on top of the area where the extra information is displayed for the respective video frame. For example, as shown in FIG. 2, the new banner 112 that contains information of an “emergent weather alert” is not to be covered, even if the user has manually turned on the visual blocker.

FIG. 3 provides an example block diagram 300 illustrating using a display advertisement as an anti-spoiler blocker, according to an embodiment described herein. In some embodiments, the media guidance application may utilize the visual blocker 113 as a space for targeted ads. Specifically, the media guidance application may retrieve, from a user profile, information relating to one or more user interested items, e.g., tennis, sports gears, Federer, US Open, etc. The media guidance application may query, an advertisement database (e.g., via storage 608 in FIG. 6 or data source 718 accessible via communications network 714 in FIG. 7), based on information relating to the one or more user interested items. For example, the media guidance application may obtain an advertisement relating to at least one user interested item such as sports gears, active wears, sports classes, and/or the like. In some embodiments, at the time when the media guidance application determines that a visual block is to be generated over the video frame, the media guidance application may send an indication that an advertisement spot is available, together with user profile information (e.g., user interest profile, etc.) to an Ad Exchange to facilitate real time ad bidding. In response to obtaining an advertisement (e.g., a pre-stored advertisement or a winning bid from the Ad Exchange), the media guidance application may adapt the advertisement into a display advertisement having a size and a shape to cover the extra information, and overlay the display advertisement 117 on top of the area where the extra information is displayed.

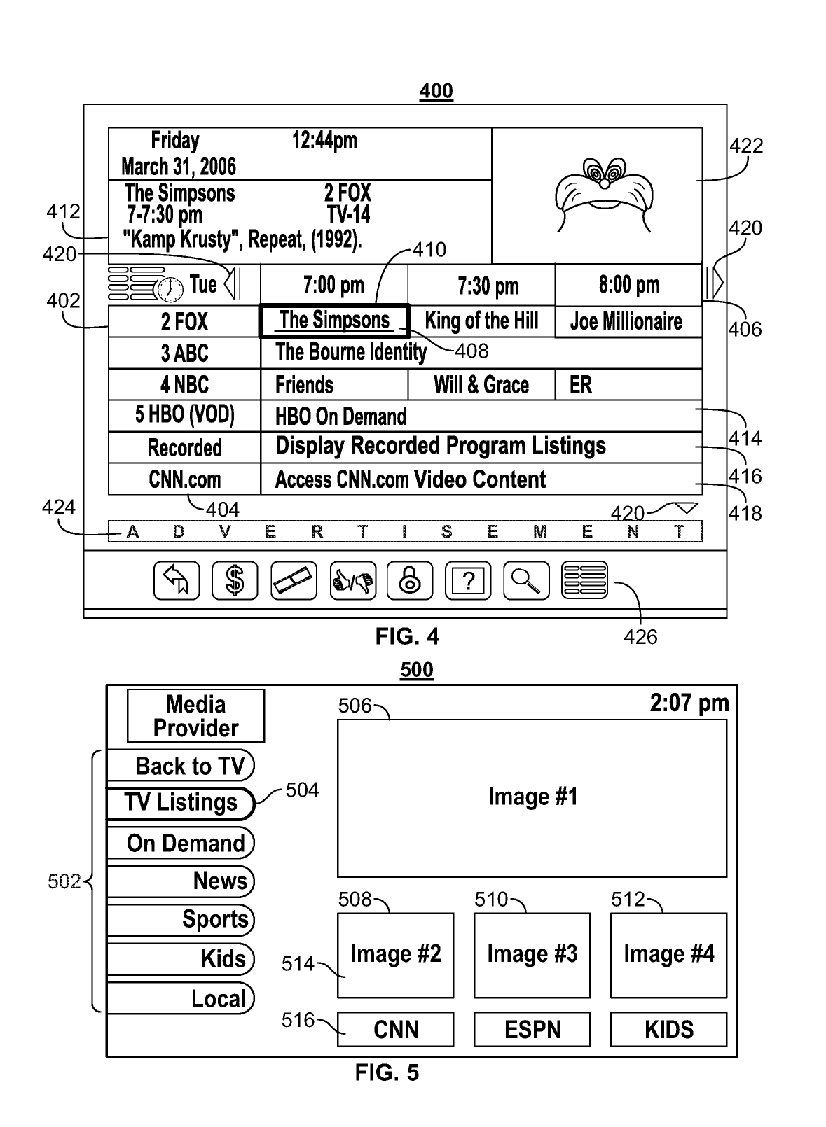

FIGS. 4-5 show illustrative display screens that may be used to provide media guidance data. The display screens shown in FIGS. 4-5 may be implemented on any suitable user equipment device or platform, e.g., user equipment 106 or the set-top box 120 in FIG. 1. While the displays of FIGS. 4-5 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 4 shows illustrative grid of a program listings display 400 arranged by time and channel that also enables access to different types of content in a single display. Display 400 may include grid 402 with: (1) a column of channel/content type identifiers 404, where each channel/content type identifier (which is a cell in the column) identifies a different channel or content type available; and (2) a row of time identifiers 406, where each time identifier (which is a cell in the row) identifies a time block of programming. Grid 402 also includes cells of program listings, such as program listing 408, where each listing provides the title of the program provided on the listing's associated channel and time. With a user input device, a user can select program listings by moving highlight region 410. Information relating to the program listing selected by highlight region 410 may be provided in program information region 412. Region 412 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 402 may provide media guidance data for non-linear programming including on-demand listing 414, recorded content listing 416, and Internet content listing 418. A display combining media guidance data for content from different types of content sources is sometimes referred to as a “mixed-media” display. Various permutations of the types of media guidance data that may be displayed that are different than display 400 may be based on user selection or guidance application definition (e.g., a display of only recorded and broadcast listings, only on-demand and broadcast listings, etc.). As illustrated, listings 414, 416, and 418 are shown as spanning the entire time block displayed in grid 402 to indicate that selection of these listings may provide access to a display dedicated to on-demand listings, recorded listings, or Internet listings, respectively. In some embodiments, listings for these content types may be included directly in grid 402. Additional media guidance data may be displayed in response to the user selecting one of the navigational icons 420. (Pressing an arrow key on a user input device may affect the display in a similar manner as selecting navigational icons 420.)

Display 400 may also include video region 422, and options region 426. Video region 422 may allow the user to view and/or preview programs that are currently available, will be available, or were available to the user. The content of video region 422 may correspond to, or be independent from, one of the listings displayed in grid 402. Grid displays including a video region are sometimes referred to as picture-in-guide (PIG) displays. PIG displays and their functionalities are described in greater detail in Satterfield et al. U.S. Pat. No. 6,564,378, issued May 13, 4003 and Yuen et al. U.S. Pat. No. 6,239,794, issued May 49, 4001, which are hereby incorporated by reference herein in their entireties. PIG displays may be included in other media guidance application display screens of the embodiments described herein.

Options region 426 may allow the user to access different types of content, media guidance application displays, and/or media guidance application features. Options region 426 may be part of display 400 (and other display screens described herein), or may be invoked by a user by selecting an on-screen option or pressing a dedicated or assignable button on a user input device. The selectable options within options region 426 may concern features related to program listings in grid 402 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 4D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.Tivo.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 5. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 5. Video mosaic display 500 includes selectable options 502 for content information organized based on content type, genre, and/or other organization criteria. In display 500, television listings option 504 is selected, thus providing listings 506, 508, 510, and 512 as broadcast program listings. In display 500 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 508 may include more than one portion, including media portion 514 and text portion 516. Media portion 514 and/or text portion 516 may be selectable to view content in full-screen or to view information related to the content displayed in media portion 514 (e.g., to view listings for the channel that the video is displayed on).

The listings in display 500 are of different sizes (i.e., listing 506 is larger than listings 508, 510, and 512), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

Users may access content and the media guidance application (and its display screens described above and below) from one or more of their user equipment devices. FIG. 6 shows a generalized embodiment of illustrative user equipment device 600. More specific implementations of user equipment devices are discussed below in connection with FIG. 7. User equipment device 600 may receive content and data via input/output (hereinafter “I/O”) path 602. I/O path 602 may provide content (e.g., broadcast programming, on-demand programming, Internet content, content available over a local area network (LAN) or wide area network (WAN), and/or other content) and data to control circuitry 604, which includes processing circuitry 606 and storage 608. Control circuitry 604 may be used to send and receive commands, requests, and other suitable data using I/O path 602. I/O path 602 may connect control circuitry 604 (and specifically processing circuitry 606) to one or more communications paths (described below). I/O functions may be provided by one or more of these communications paths, but are shown as a single path in FIG. 6 to avoid overcomplicating the drawing.

Control circuitry 604 may be based on any suitable processing circuitry such as processing circuitry 606. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 604 executes instructions for a media guidance application stored in memory (i.e., storage 608). Specifically, control circuitry 604 may be instructed by the media guidance application to perform the functions discussed above and below. For example, the media guidance application may provide instructions to control circuitry 604 to generate the media guidance displays. In some implementations, any action performed by control circuitry 604 may be based on instructions received from the media guidance application.

In client-server based embodiments, control circuitry 604 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 7). In addition, communications circuitry may include circuitry that enables peer-to-peer communication of user equipment devices, or communication of user equipment devices in locations remote from each other (described in more detail below).

Memory may be an electronic storage device provided as storage 608 that is part of control circuitry 604. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 608 may be used to store various types of content described herein as well as media guidance data described above. Nonvolatile memory may also be used (e.g., to launch a boot-up routine and other instructions). Cloud-based storage, described in relation to FIG. 7, may be used to supplement storage 608 or instead of storage 608.

Control circuitry 604 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 604 may also include scaler circuitry for upconverting and downconverting content into the preferred output format of the user equipment 600. Circuitry 404 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 608 is provided as a separate device from user equipment 600, the tuning and encoding circuitry (including multiple tuners) may be associated with storage 608.

A user may send instructions to control circuitry 604 using user input interface 610. User input interface 610 may be any suitable user interface, such as a remote control, mouse, trackball, keypad, keyboard, touch screen, touchpad, stylus input, joystick, voice recognition interface, or other user input interfaces. Display 612 may be provided as a stand-alone device or integrated with other elements of user equipment device 600. For example, display 612 may be a touchscreen or touch-sensitive display. In such circumstances, user input interface 610 may be integrated with or combined with display 612. Display 612 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 612 may be HDTV-capable. In some embodiments, display 612 may be a 3D display, and the interactive media guidance application and any suitable content may be displayed in 3D. A video card or graphics card may generate the output to the display 612. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 604. The video card may be integrated with the control circuitry 604. Speakers 614 may be provided as integrated with other elements of user equipment device 600 or may be stand-alone units. The audio component of videos and other content displayed on display 612 may be played through speakers 614. In some embodiments, the audio may be distributed to a receiver (not shown), which processes and outputs the audio via speakers 614.

The guidance application may be implemented using any suitable architecture. For example, it may be a stand-alone application wholly-implemented on user equipment device 600. In such an approach, instructions of the application are stored locally (e.g., in storage 608), and data for use by the application is downloaded on a periodic basis (e.g., from an out-of-band feed, from an Internet resource, or using another suitable approach). Control circuitry 604 may retrieve instructions of the application from storage 608 and process the instructions to generate any of the displays discussed herein. Based on the processed instructions, control circuitry 604 may determine what action to perform when input is received from input interface 610. For example, movement of a cursor on a display up/down may be indicated by the processed instructions when input interface 610 indicates that an up/down button was selected.

In some embodiments, the media guidance application is a client-server based application. Data for use by a thick or thin client implemented on user equipment device 600 is retrieved on-demand by issuing requests to a server remote to the user equipment device 600. In one example of a client-server based guidance application, control circuitry 604 runs a web browser that interprets web pages provided by a remote server. For example, the remote server may store the instructions for the application in a storage device. The remote server may process the stored instructions using circuitry (e.g., control circuitry 604) and generate the displays discussed above and below. The client device may receive the displays generated by the remote server and may display the content of the displays locally on equipment device 600. This way, the processing of the instructions is performed remotely by the server while the resulting displays are provided locally on equipment device 600. Equipment device 600 may receive inputs from the user via input interface 610 and transmit those inputs to the remote server for processing and generating the corresponding displays. For example, equipment device 600 may transmit a communication to the remote server indicating that an up/down button was selected via input interface 610. The remote server may process instructions in accordance with that input and generate a display of the application corresponding to the input (e.g., a display that moves a cursor up/down). The generated display is then transmitted to equipment device 600 for presentation to the user.

In some embodiments, the media guidance application is downloaded and interpreted or otherwise run by an interpreter or virtual machine (run by control circuitry 604). In some embodiments, the guidance application may be encoded in the ETV Binary Interchange Format (EBIF), received by control circuitry 604 as part of a suitable feed, and interpreted by a user agent running on control circuitry 604. For example, the guidance application may be an EBIF application. In some embodiments, the guidance application may be defined by a series of JAVA-based files that are received and run by a local virtual machine or other suitable middleware executed by control circuitry 604. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 600 of FIG. 6 can be implemented in system 600 of FIG. 6 as user television equipment 602, user computer equipment 604, wireless user communications device 606, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 7 may not be classified solely as user television equipment 702, user computer equipment 704, or a wireless user communications device 706. For example, user television equipment 702 may, like some user computer equipment 704, be Internet-enabled allowing for access to Internet content, while user computer equipment 704 may, like some television equipment 702, include a tuner allowing for access to television programming. The media guidance application may have the same layout on various different types of user equipment or may be tailored to the display capabilities of the user equipment. For example, on user computer equipment 704, the guidance application may be provided as a web site accessed by a web browser. In another example, the guidance application may be scaled down for wireless user communications devices 706.

In system 700, there is typically more than one of each type of user equipment device but only one of each is shown in FIG. 7 to avoid overcomplicating the drawing. In addition, each user may utilize more than one type of user equipment device and also more than one of each type of user equipment device.

In some embodiments, a user equipment device (e.g., user television equipment 702, user computer equipment 704, wireless user communications device 706) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.Tivo.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 714. Namely, user television equipment 702, user computer equipment 704, and wireless user communications device 706 are coupled to communications network 714 via communications paths 708, 710, and 712, respectively. Communications network 714 may be one or more networks including the Internet, a mobile phone network, mobile voice or data network (e.g., a 4G or LTE network), cable network, public switched telephone network, or other types of communications network or combinations of communications networks. Paths 708, 710, and 712 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 712 is drawn with dotted lines to indicate that in the exemplary embodiment shown in FIG. 7 it is a wireless path and paths 708 and 710 are drawn as solid lines to indicate they are wired paths (although these paths may be wireless paths, if desired). Communications with the user equipment devices may be provided by one or more of these communications paths, but are shown as a single path in FIG. 7 to avoid overcomplicating the drawing.

Although communications paths are not drawn between user equipment devices, these devices may communicate directly with each other via communication paths, such as those described above in connection with paths 708, 710, and 712, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 714.

System 700 includes content source 716 and media guidance data source 718 coupled to communications network 714 via communication paths 720 and 722, respectively. Paths 720 and 722 may include any of the communication paths described above in connection with paths 708, 710, and 712. Communications with the content source 716 and media guidance data source 718 may be exchanged over one or more communications paths, but are shown as a single path in FIG. 7 to avoid overcomplicating the drawing. In addition, there may be more than one of each of content source 716 and media guidance data source 718, but only one of each is shown in FIG. 7 to avoid overcomplicating the drawing. (The different types of each of these sources are discussed below.) If desired, content source 716 and media guidance data source 718 may be integrated as one source device. Although communications between sources 716 and 718 with user equipment devices 702, 704, and 706 are shown as through communications network 714, in some embodiments, sources 716 and 718 may communicate directly with user equipment devices 702, 704, and 706 via communication paths (not shown) such as those described above in connection with paths 708, 710, and 712.

Content source 716 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 716 may be the originator of content (e.g., a television broadcaster, a Webcast provider, etc.) or may not be the originator of content (e.g., an on-demand content provider, an Internet provider of content of broadcast programs for downloading, etc.). Content source 716 may include cable sources, satellite providers, on-demand providers, Internet providers, over-the-top content providers, or other providers of content. Content source 716 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 718 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 718 may be provided to users” equipment using a client-server approach. For example, a user equipment device may pull media guidance data from a server, or a server may push media guidance data to a user equipment device. In some embodiments, a guidance application client residing on the user's equipment may initiate sessions with source 718 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 718 may provide user equipment devices 702, 704, and 706 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 408, and executed by control circuitry 604 of a user equipment device 400. In some embodiments, media guidance applications may be client-server applications where only a client application resides on the user equipment device, and server application resides on a remote server. For example, media guidance applications may be implemented partially as a client application on control circuitry 604 of user equipment device 600 and partially on a remote server as a server application (e.g., media guidance data source 718) running on control circuitry of the remote server. When executed by control circuitry of the remote server (such as media guidance data source 718), the media guidance application may instruct the control circuitry to generate the guidance application displays and transmit the generated displays to the user equipment devices. The server application may instruct the control circuitry of the media guidance data source 718 to transmit data for storage on the user equipment. The client application may instruct control circuitry of the receiving user equipment to generate the guidance application displays.

Content and/or media guidance data delivered to user equipment devices 702, 704, and 706 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 700 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 7.

In one approach, user equipment devices may communicate with each other within a home network. User equipment devices can communicate with each other directly via short-range point-to-point communication schemes described above, via indirect paths through a hub or other similar device provided on a home network, or via communications network 714. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 716 to access content. Specifically, within a home, users of user television equipment 702 and user computer equipment 704 may access the media guidance application to navigate among and locate desirable content. Users may also access the media guidance application outside of the home using wireless user communications devices 706 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 714. These cloud resources may include one or more content sources 716 and one or more media guidance data sources 718. In addition or in the alternative, the remote computing sites may include other user equipment devices, such as user television equipment 702, user computer equipment 704, and wireless user communications device 706. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 704 or wireless user communications device 706 having content capture feature. Alternatively, the user can first transfer the content to a user equipment device, such as user computer equipment 704. The user equipment device storing the content uploads the content to the cloud using a data transmission service on communications network 714. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 6.

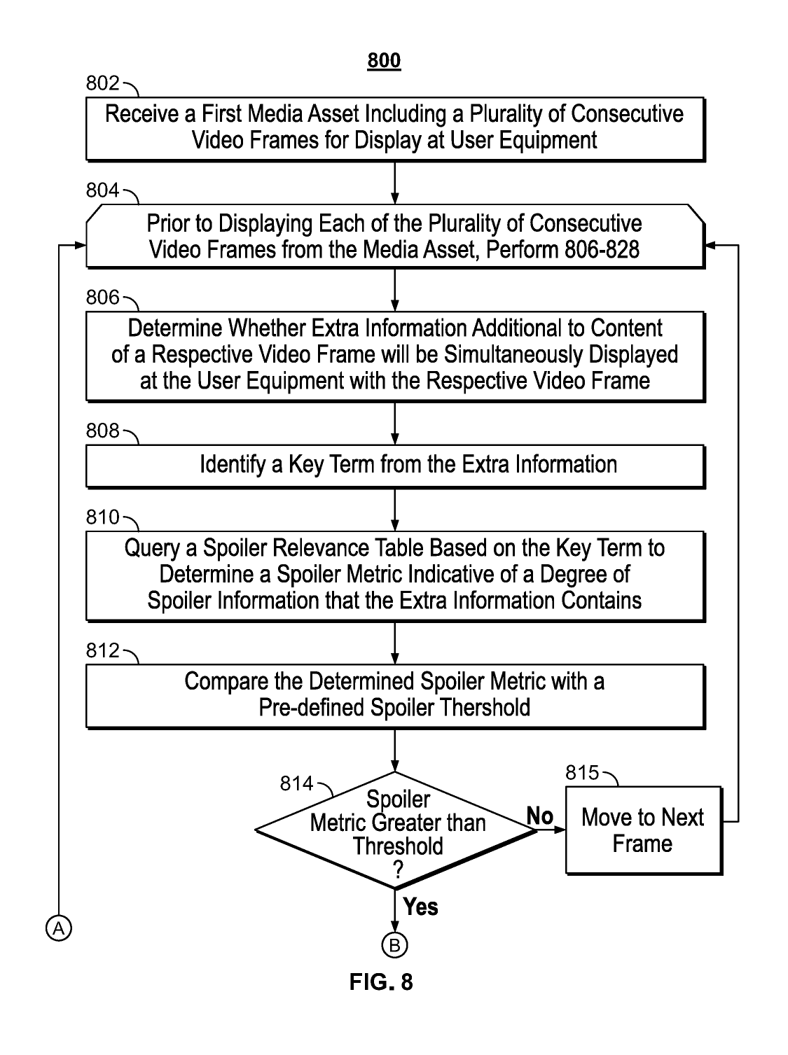

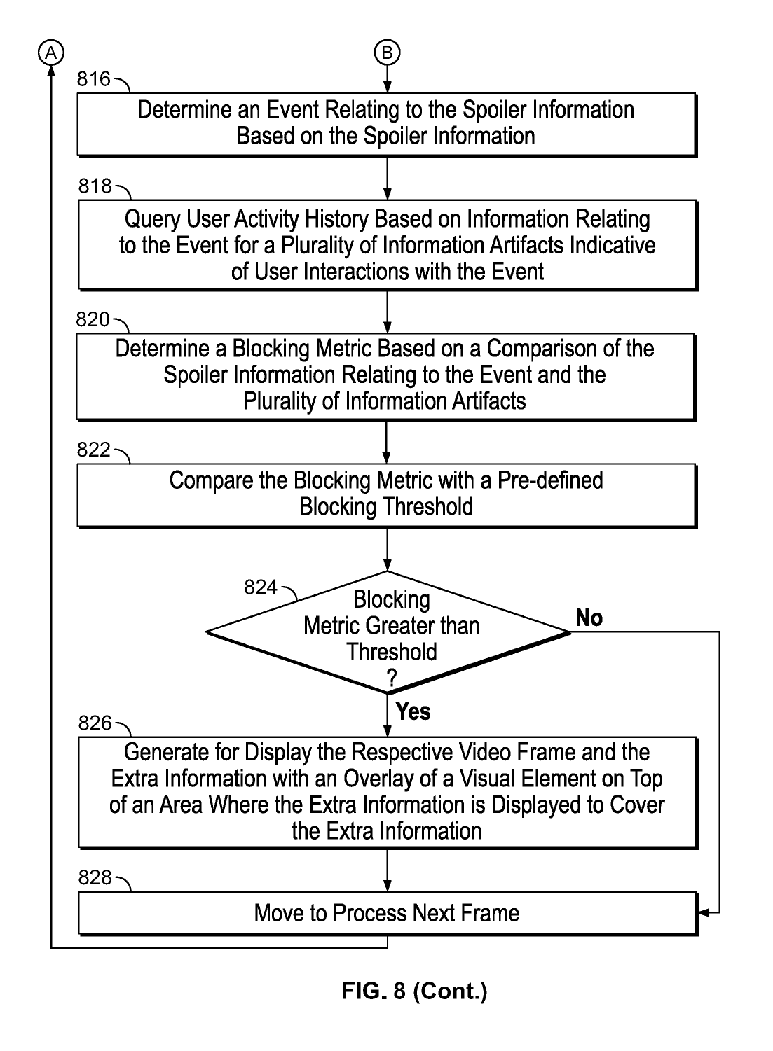

FIG. 8 depicts an illustrative flowchart of a process for detecting spoiler information displayed simultaneously with a media asset and providing a visual element to block display of the spoiler information, in accordance with some embodiments of the disclosure. Process 800 may be executed by control circuitry 604 (e.g., in a manner instructed to control circuitry 604 by the media guidance application). Control circuitry 604 may be part of user equipment (e.g., user equipment 106, user television equipment 702, user computer equipment 704, and/or wireless communications device 706), or of a remote server separated from the user equipment by way of communications network 714.

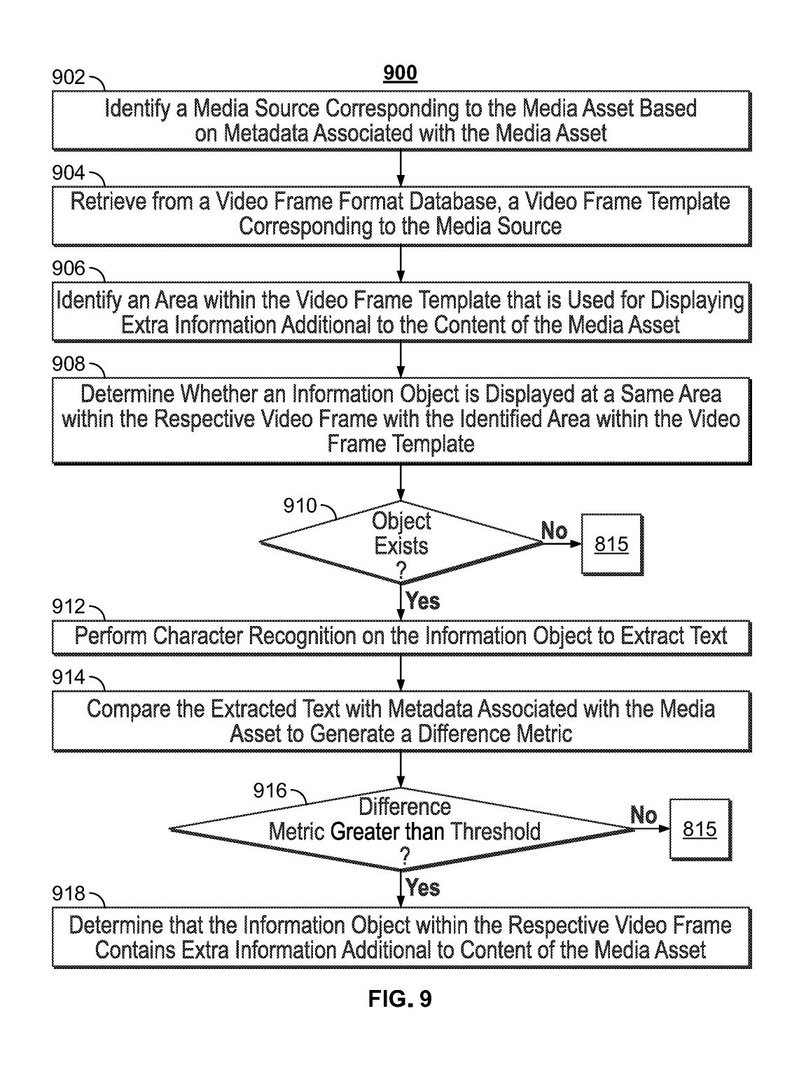

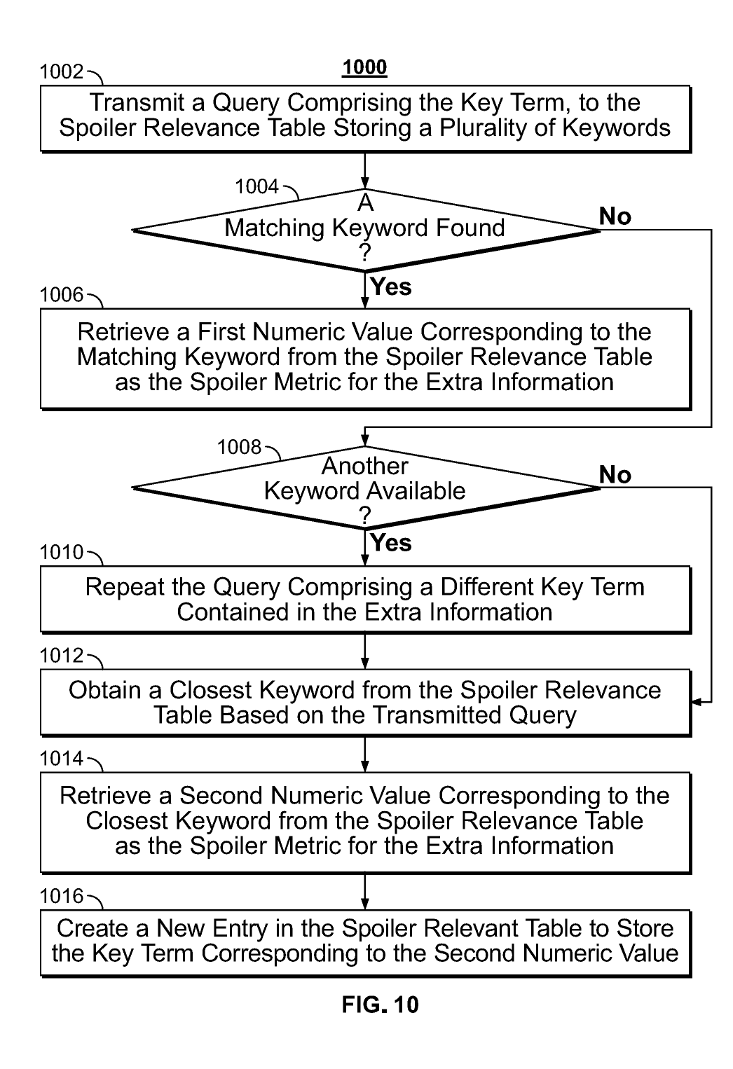

Process 800 begins at 802, where control circuitry 604 receives, a first media asset including a plurality of consecutive video frames for display at user equipment. For example, control circuitry 604 receives the first media asset from the media content source 716 via the communications network 714 in FIG. 7, and then load the video frames of the first media asset at a buffer in the storage 608 in FIG. 6 for further processing. At 804, prior to displaying each of the plurality of consecutive video frames from the media asset, e.g., from a buffer in storage 608 to the display 612 in FIG. 6, control circuitry 604 determines whether extra information additional to content of a respective video frame will be simultaneously displayed at the user equipment with the respective video frame. The determination of extra information is further described in FIG. 9. At 808, control circuitry 604 identifies a key term from the extra information. At 810, control circuitry 604 queries a spoiler relevance table based on the key term to determine a spoiler metric indicative of a degree of spoiler information that the extra information contains. For example, control circuitry 604 retrieves the spoiler relevance table, which may take a form similar to Table 1, from storage 608 in FIG. 6, or data source 718 via communications network 714 in FIG. 7. Further detail of the determination of the spoiler metric is described in FIG. 10.

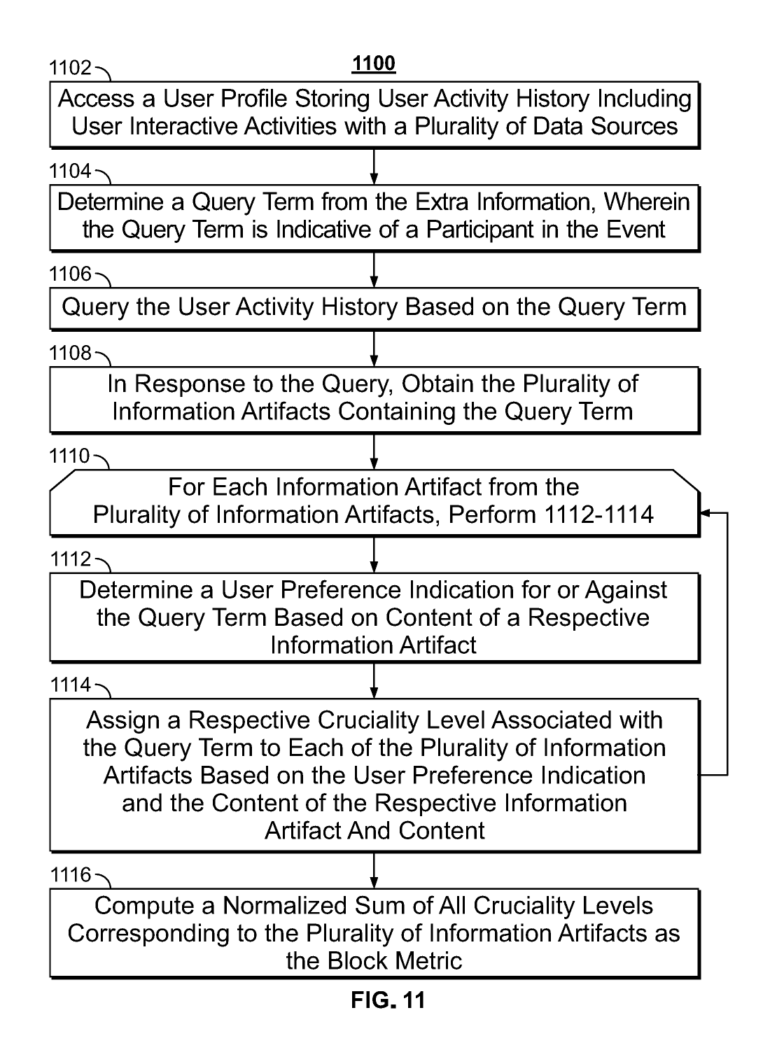

At 812, control circuitry 604 compares the determined spoiler metric with a pre-defined spoiler threshold. For example, control circuitry 604 include a comparator to input the determined spoiler metric and the pre-defined spoiler threshold. At 814, when the determined spoiler metric is no greater than the threshold, process 800 continues to 815, where control circuitry 604 moves to the next video frame, and process 800 proceeds to 804. At 814, when the determined spoiler metric is greater than the threshold, process 800 continues to 816, where control circuitry 604 determines an event relating to the spoiler information based on the spoiler information. For example, control circuitry 604 retrieves metadata associated with the media asset from storage 608 in FIG. 6 to identify a name for the event. At 818, control circuitry 604 queries user activity history based on information relating to the event for a plurality of information artifacts indicative of user interactions with the event. For example, control circuitry 604 retrieves the user activity history from storage 608 in FIG. 6 or data source 718 via communications network 714 in FIG. 7. At 820, control circuitry 604 determines a blocking metric based on a comparison of the spoiler information relating to the event and the plurality of information artifacts, as further described in FIG. 11.

At 822, control circuitry 604 compares the blocking metric with a pre-defined blocking threshold, e.g., via a comparator connecting to the block metric and the pre-defined blocking threshold. At 824, when the blocking metric is greater than the pre-defined blocking threshold, process 800 continues to 826, where control circuitry 604 generates for display, e.g., via display 612 in FIG. 6, the respective video frame and the extra information with an overlay of a visual element on top of an area where the extra information is displayed to cover the extra information. For example, control circuitry 604 generates the visual element with the size and shape to render the extra information invisible. At 824, when the blocking metric is no greater than the pre-defined blocking threshold, process 800 continues to 828, where control circuitry 604 moves to process the next frame and continues with 804.

FIG. 9 depicts an illustrative flowchart of a process for detecting spoiler information displayed simultaneously with a media asset and providing a visual element to block display of the spoiler information (e.g., see 806 in FIG. 8), in accordance with some embodiments of the disclosure. Process 900 may be executed by control circuitry 604 (e.g., in a manner instructed to control circuitry 604 by the media guidance application). Control circuitry 604 may be part of user equipment (e.g., user equipment 106, user television equipment 702, user computer equipment 704, and/or wireless communications device 706), or of a remote server separated from the user equipment by way of communications network 714.

Process 900 begins at 902, where control circuitry 604 identifies a media source corresponding to the media asset based on metadata associated with the media asset. For example, control circuitry 604 parses the metadata associated with the media asset to read a data field for the media source. At 904, control circuitry 604 retrieves, from a video frame format database at storage 608 in FIG. 6, or data source 718 via communications network 714 in FIG. 7, a video frame template corresponding to the media source. At 906, control circuitry 604 identifies an area within the video frame template that is used for displaying extra information additional to the content of the media asset. For example, control circuitry 604 reads the coordinates defined in the template data that identifies the position of the area to display extra information within the video frame template, as described in relation to FIG. 1. At 908, control circuitry 605 determines whether an information object is displayed at a same area within the respective video frame with the identified area within the video frame template. At 910, when an information object is displayed at the same area within the respective video frame with the identified area within the video frame template, process 900 proceeds to 912, where control circuitry 604 performs character recognition on the information object to extract text. Otherwise, control circuitry 604 proceeds to 815 in FIG. 8 to move to the next frame.

At 914, control circuitry 604 compares the extracted text with metadata associated with the media asset to generate a difference metric, e.g., via a comparator with inputs of a string of the extracted text and a string of the metadata. At 916, when the difference metric is higher than a difference threshold, process 900 proceeds to 918, where control circuitry 604 determines that the information object within the respective video frame contains extra information additional to content of the media asset. Otherwise, control circuitry 604 proceeds to proceeds to 815 in FIG. 8 to move to the next frame.

FIG. 10 depicts an illustrative flowchart of a process for querying a spoiler relevance table based on the key term to determine a spoiler metric indicative of a degree of spoiler information that the extra information contains (e.g., see 810 in FIG. 8), in accordance with some embodiments of the disclosure. Process 1000 may be executed by control circuitry 604 (e.g., in a manner instructed to control circuitry 604 by the media guidance application). Control circuitry 604 may be part of user equipment (e.g., user equipment 106, user television equipment 702, user computer equipment 704, and/or wireless communications device 706), or of a remote server separated from the user equipment by way of communications network 714.

Process 1000 begins at 1002, where control circuitry 604 transmits a query comprising the key term, to the spoiler relevance table storing a plurality of keywords. For example, control circuitry 604 may transmit the query to storage 608 in FIG. 6 or data source 718 in FIG. 7 where the spoiler relevance table is stored. At 1004, when a query result of a matching keyword is returned, process 1000 proceeds to 1006, where control circuitry 604 retrieves a first numeric value corresponding to the matching keyword from the spoiler relevance table as the spoiler metric for the extra information, as described in relation to Table 1 and FIG. 1. At 1004, when a query result of an exact matching keyword is not returned, control circuitry 604 moves on to a next keyword at 1008. At 1008, if the next keyword from the extra information exists, control circuitry 604 repeats the query comprising a different key term contained in the extra information. Or, if the next keyword from the extra information does not exist, control circuitry 604 obtains a closest keyword from the spoiler relevance table based on the transmitted query, e.g., as described in relation to Table 1 and FIG. 1. At 1014, control circuitry 604 retrieves a second numeric value corresponding to the closest keyword from the spoiler relevance table as the spoiler metric for the extra information. At 1016, control circuitry 604 creates a new entry in the spoiler relevance table to store the key term corresponding to the second numeric value, e.g., at storage 608 in FIG. 6 or data source 718 in FIG. 7 where the spoiler relevance table is stored.

FIG. 11 depicts an illustrative flowchart of a process for querying of the user activity history based on information relating to the event for a plurality of information artifacts indicative of user interactions with the event (e.g., see 818 in FIG. 8), in accordance with some embodiments of the disclosure. Process 1100 may be executed by control circuitry 604 (e.g., in a manner instructed to control circuitry 604 by the media guidance application). Control circuitry 604 may be part of user equipment (e.g., user equipment 106, user television equipment 702, user computer equipment 704, and/or wireless communications device 706), or of a remote server separated from the user equipment by way of communications network 714.

Process 1100 begins at 1102, where control circuitry 604 accesses a user profile storing user activity history including user interactive activities with a plurality of data sources. For example, control circuitry 604 retrieves the user profile from storage 608 in FIG. 6, or data source 718 in FIG. 7. At 1104, control circuitry 604 determines a query term from the extra information. For example, the query term is indicative of a participant in the event, e.g., “Federer” in the “US Open men's ingle.” At 1106, control circuitry 604 queries the user activity history based on the query term. At 110, in response to the query, control circuitry 604 obtains the plurality of information artifacts containing the query term. For example, the plurality of information artifacts contain instances user comments, user “likes” of social media posts, user scheduled recordings, user viewing history of recordings, and/or the like. At 1110, for each information artifact from the plurality of information artifacts, control circuitry 604 determines a user preference indication for or against the query term based on content of a respective information artifact. For example, the information artifact of a social media subscription of “Federer” page may indicate the user preference for the participant “Federer.” At 1114, control circuitry 604 assigns a respective cruciality level associated with the query term to each of the plurality of information artifacts based on the user preference indication and the content of the respective information artifact and content, and may repeat 1112-1114 for each information artifact. For example, control circuitry 604 assigns to the artifact indicating that the user has subscribed to the channel of the player “Federer” on social media a relatively high cruciality score. For another example, control circuitry 604 assigns to the artifact indicating that the user has scheduled to record the men's single final game involving the player “Federer” a relatively high cruciality score. At 1116, control circuitry 604 computes a normalized sum of all cruciality levels corresponding to the plurality of information artifacts as the block metric. For example, control circuitry 604 computers an average value of the cruciality levels of the information artifacts. For another example, control circuitry 604 computes a weighted sum of the cruciality levels of the information artifacts, with pre-defined weights based on different types of information artifacts—e.g., a scheduled recording may be associated with a higher weight, while a social media “like” on a news link relating to a participant or an event may be associated with a relatively lower weight, and/or the like.

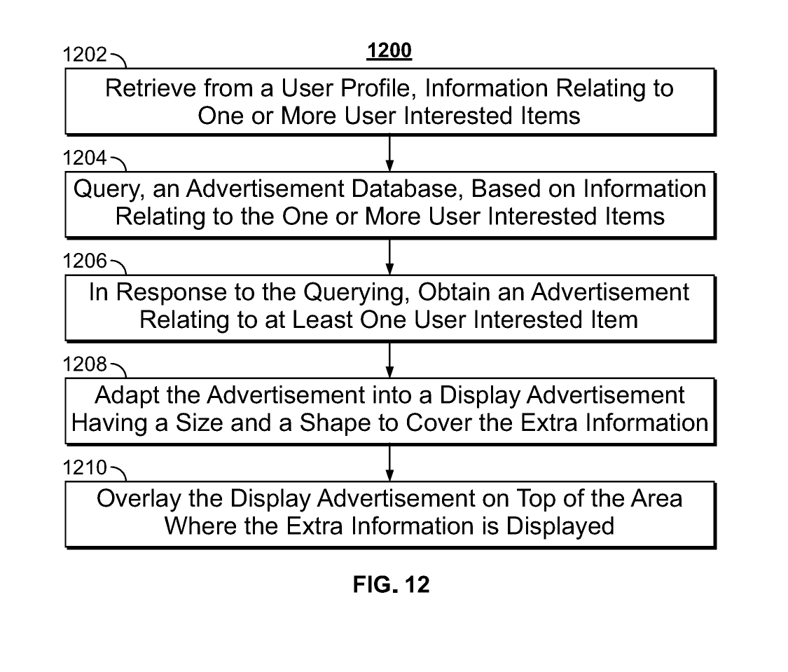

FIG. 12 depicts an illustrative flowchart of a process for generating for display of the respective video frame and the extra information with an overlay of a visual element on top of an area where the extra information is displayed to cover the extra information (e.g., see 826 in FIG. 8), in accordance with some embodiments of the disclosure. Process 1200 may be executed by control circuitry 604 (e.g., in a manner instructed to control circuitry 604 by the media guidance application). Control circuitry 604 may be part of user equipment (e.g., user equipment 106, user television equipment 702, user computer equipment 704, and/or wireless communications device 706), or of a remote server separated from the user equipment by way of communications network 714.

Process 1200 begins at 1202, where control circuitry 604 retrieves, from a user profile (e.g., stored at storage 608 in FIG. 6 or data source 718 in FIG. 7), information relating to one or more user interested items. At 1204, control circuitry 604 queries, an advertisement database, e.g., via storage 608 in FIG. 6 or data source 718 in FIG. 7, based on information relating to the one or more user interested items. For example, the one or more user interested items may include “sports,” “sports gear,” “tennis,” “athletic wear,” and/or the like. At 1206, control circuitry 604, in response to the querying, obtains an advertisement relating to at least one user interested item. For example, control circuitry 604 receives advertising data from data source 718 in FIG. 7. At 1208, control circuitry 604 adapts the advertisement into a display advertisement having a size and a shape to cover the extra information. At 1210, control circuitry 604 overlays the display advertisement on top of the area where the extra information is displayed, e.g., as shown in FIG. 3.

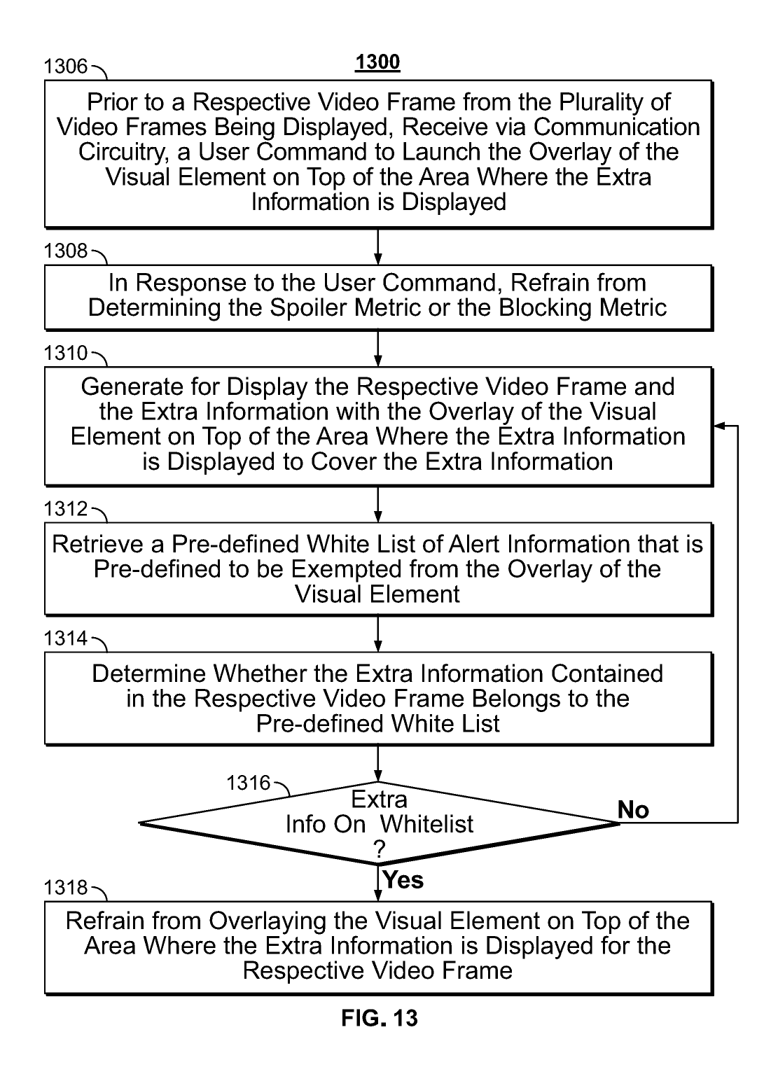

FIG. 13 depicts an illustrative flowchart of a process for processing anti-spoiler visual block with a pre-defined whitelist of items, in accordance with some embodiments of the disclosure. Process 1300 may be executed by control circuitry 604 (e.g., in a manner instructed to control circuitry 604 by the media guidance application). Control circuitry 604 may be part of user equipment (e.g., user equipment 106, user television equipment 702, user computer equipment 704, and/or wireless communications device 706), or of a remote server separated from the user equipment by way of communications network 714.

Process 1300 begins at 1306, where control circuitry 604, prior to a respective video frame from the plurality of video frames being displayed, receives, via communication circuitry (e.g., the user input interface 610, or the input/output path 602 in FIG. 6), a user command to launch the overlay of the visual element on top of the area where the extra information is displayed. At 1308, in response to the user command, control circuitry 604 refrains from determining the spoiler metric or the blocking metric. At 1310, control circuitry 604 generates for display, e.g., via display 612 in FIG. 6, the respective video frame and the extra information with the overlay of the visual element on top of the area where the extra information is displayed to cover the extra information. At 1312, control circuitry 604 retrieves, e.g., from storage 608 in FIG. 6 or data source 718 in FIG. 7, a pre-defined white list of alert information that is pre-defined to be exempted from the overlay of the visual element. At 1314, control circuitry 604 determines whether the extra information contained in the respective video frame belongs to the pre-defined white list. At 1316, when the extra information is on whitelist, e.g., when the extra information relates to weather alerts, safety alerts, etc., control circuitry 604 refrains from overlaying the visual element on top of the area where the extra information is displayed for the respective video frame at 1318. Otherwise, process 1300 proceeds to 1310.

It should be noted that processes 800-1300 or any step thereof could be performed on, or provided by, any of the devices shown in, or described with respect to, FIGS. 1-3 and 6-7. For example, any of processes 800-1100 may be executed by control circuitry 604 (FIG. 6) as instructed by control circuitry implemented on user equipment 106 (FIG. 1), 702, 704, 706 (FIG. 6), and/or the like for generating and displaying a summary view of a media asset. In addition, one or more steps of processes 800-1300 may be incorporated into or combined with one or more steps of any other process or embodiment.

It is contemplated that the actions or descriptions of each of FIGS. 8-13 may be used with any other embodiment of this disclosure. In addition, the actions and descriptions described in relation to FIGS. 8-13 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 1-13 could be used to perform one or more of the actions in FIGS. 8-13.

It will be apparent to those of ordinary skill in the art that methods involved in the present disclosure may be embodied in a computer program product that includes a computer-usable and/or readable medium. For example, such a computer-usable medium may consist of a read-only memory device, such as a CD-ROM disk or conventional ROM device, or a random access memory, such as a hard drive device or a computer diskette, having a computer-readable program code stored thereon. It should also be understood that methods, techniques, and processes involved in the present disclosure may be executed using processing circuitry. For instance, determining a blocking metric based on a comparison of the spoiler information relating to the event and the plurality of information artifacts, e.g., by processing circuitry 606 of FIG. 6. The processing circuitry, for instance, may be a general purpose processor, a customized integrated circuit (e.g., an ASIC), or a field-programmable gate array (FPGA) within user equipment 600, media content source 716, or media guidance data source 718. For example, the attributes of media assets, may be stored in, and retrieved from, storage 608 of FIG. 6, or media guidance data source 718 of FIG. 7. Furthermore, processing circuitry, or a computer program, may update configuration data of the media guidance application, which may be stored within storage 608 of FIG. 6 or media guidance data source 718 of FIG. 7.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

While some portions of this disclosure may make reference to “convention,” any such reference is merely for the purpose of providing context to the invention(s) of the instant disclosure, and does not form any admission as to what constitutes the state of the art.

1. (canceled)

2. A method for detecting spoiler information displayed simultaneously with a media asset and providing a visual element to block display of the spoiler information, the method comprising:
receiving, a first media asset including a plurality of consecutive video frames for display at user equipment;
prior to displaying each of the plurality of consecutive video frames from the media asset:
determining whether extra information additional to content of a respective video frame will be simultaneously displayed at the user equipment with the respective video frame;
in response to determining that the extra information will be simultaneously displayed with the respective video frame:
identifying a key term from the extra information;
querying a spoiler relevance table based on the key term to determine a spoiler metric indicative of a degree of spoiler information that the extra information contains;
comparing the determined spoiler metric with a pre-defined spoiler threshold;
in response to determining that the spoiler metric is greater than the pre-defined spoiler threshold:
determining an event relating to the spoiler information based on the spoiler information;
querying a user activity history based on information relating to the event for a plurality of information artifacts indicative of social media interactions with the event;
determining, based on the social media interactions, a user preference for the event;
determining a blocking metric based on a comparison of the spoiler information relating to the event and the user preference for the event;
comparing the blocking metric with a pre-defined blocking threshold; and
in response to determining that the blocking metric is greater than the pre-defined blocking threshold, generating for display the respective video frame and the extra information with an overlay of a visual element on top of an area where the extra information is displayed to cover the extra information.

3. The method of claim 2, wherein the determining whether extra information additional to content of the media asset will be simultaneously displayed at the user equipment with the respective video frame comprises:
identifying a media source corresponding to the media asset based on metadata associated with the media asset;
retrieving, from a video frame format database, a video frame template corresponding to the media source;
identifying an area within the video frame template that is used for displaying extra information additional to the content of the media asset;
determining whether an information object is displayed at a same area within the respective video frame with the identified area within the video frame template;
in response to determining that the information object is displayed at the same area within the respective video frame with the identified area within the video frame template, performing character recognition on the information object to extract text;
comparing the extracted text with metadata associated with the media asset to generate a difference metric;
in response to determining that the difference metric is higher than a difference threshold, determining that the information object within the respective video frame contains extra information additional to content of the media asset.

4. The method of claim 2, wherein the querying a spoiler relevance table based on the key term to determine a spoiler metric indicative of a degree of spoiler information that the extra information contains comprises:
transmitting a query comprising the key term, to the spoiler relevance table storing a plurality of keywords, each of the plurality of keywords being associated with a numeric value indicating a degree of spoiler relevance that the respective keyword corresponds to;
in response to receiving a matching keyword from the spoiler relevance table identified for the key term, retrieving a first numeric value corresponding to the matching keyword from the spoiler relevance table as the spoiler metric for the extra information; and
in response to receiving no matching keyword from the spoiler relevance table identified for the key term:
obtaining a closest keyword from the spoiler relevance table based on the transmitted query;
retrieving a second numeric value corresponding to the closest keyword from the spoiler relevance table as the spoiler metric for the extra information; and
creating a new entry in the spoiler relevant table to store the key term corresponding to the second numeric value.

5. The method of claim 2, wherein the determining an event relating to the spoiler information based on the spoiler information comprises:
transmitting, to a data source of data artifacts, a query based on the spoiler information;
in response to the transmitted query, obtaining one or more data artifacts containing information that matches the spoiler information; and
parsing the one or more obtained data artifacts to identify information of the event relating to the spoiler information, wherein the information of the event is selected from a group consisting of an event name, an event start date, an event end date, an event sponsor name, an event type, an event schedule, an event roster, and a competition result of the event.

6. The method of claim 2, wherein the querying of the user activity history based on information relating to the event for a plurality of information artifacts indicative of social media interactions with the event comprises:
accessing a user profile storing the user activity history including user interactive activities with a plurality of data sources;
determining a query term from the extra information, wherein the query term is indicative of a participant in the event;
querying the user activity history based on the query term; and
in response to the query, obtaining the plurality of information artifacts containing the query term.

7. The method of claim 2, wherein the determining of the blocking metric based on a comparison of the spoiler information relating to the event and the user preference for the event comprises:
for each information artifact from the plurality of information artifacts:
determining a user preference indication for or against the query term based on content of a respective information artifact;
assigning a respective cruciality level associated with the query term to each of the plurality of information artifacts based on the user preference indication and the content of the respective information artifact and content; and
computing a normalized sum of all cruciality levels corresponding to the plurality of information artifacts as the block metric.

8. The method of claim 2, wherein the generating for display the respective video frame and the extra information with an overlay of a visual element on top of an area where the extra information is displayed to cover the extra information comprises:
determining, from the extra information and by text recognition, a first text displayed at a first area within the respective video frame and a second text at a second area within the respective video frame;
determining that the first text includes the spoiler information and the second text does not include the spoiler information by querying the spoiler relevance table; and
configuring size and shape parameters of the visual element to have the visual element cover the first area and to prevent the visual element to cover the second area.

9. The method of claim 2, wherein the generating for display of the respective video frame and the extra information with an overlay of a visual element on top of an area where the extra information is displayed to cover the extra information comprises:
retrieving, from a user profile, information relating to one or more user interested items;
querying, an advertisement database, based on information relating to the one or more user interested items;
in response to the querying, obtaining an advertisement relating to at least one user interested item;
adapting the advertisement into a display advertisement having a size and a shape to cover the extra information; and
overlaying the display advertisement on top of the area where the extra information is displayed.

10. The method of claim 2, further comprising:
prior to a respective video frame from the plurality of video frames being displayed, receiving, via communication circuitry, a user command to launch the overlay of the visual element on top of the area where the extra information is displayed;
in response to the user command, refraining from determining the spoiler metric or the blocking metric; and
generating for display the respective video frame and the extra information with the overlay of the visual element on top of the area where the extra information is displayed to cover the extra information.

11. The method of claim 10, further comprising:
in response to receiving the user command:
retrieving a pre-defined white list of alert information that is pre-defined to be exempted from the overlay of the visual element;
determining whether the extra information contained in the respective video frame belongs to the pre-defined white list; and
in response to determining that the extra information contained in the respective video frame belongs to the pre-defined white list, refraining from overlaying the visual element on top of the area where the extra information is displayed for the respective video frame.

12. A system for detecting spoiler information displayed simultaneously with a media asset and providing a visual element to block display of the spoiler information, the system comprising:
memory;
processing circuitry configured to:
receive, a first media asset including a plurality of consecutive video frames for display at user equipment;
prior to displaying each of the plurality of consecutive video frames from the media asset:
determine whether extra information additional to content of a respective video frame will be simultaneously displayed at the user equipment with the respective video frame;
in response to determining that the extra information will be simultaneously displayed with the respective video frame:
identify a key term from the extra information;
query a spoiler relevance table based on the key term to determine a spoiler metric indicative of a degree of spoiler information that the extra information contains;
compare the determined spoiler metric with a pre-defined spoiler threshold;
in response to determining that the spoiler metric is greater than the pre-defined spoiler threshold:
determine an event relating to the spoiler information based on the spoiler information;
query a user activity history based on information relating to the event for a plurality of information artifacts indicative of social media interactions with the event;
determine, based on the social media interactions, a user preference for the event;
determine a blocking metric based on a comparison of the spoiler information relating to the event and the user preference for the event;
compare the blocking metric with a pre-defined blocking threshold; and
in response to determining that the blocking metric is greater than the pre-defined blocking threshold, generate for display the respective video frame and the extra information with an overlay of a visual element on top of an area where the extra information is displayed to cover the extra information.

13. The system of claim 12, wherein the processing circuitry, when determining whether extra information additional to content of the media asset will be simultaneously displayed at the user equipment with the respective video frame, is further configured to:
identify a media source corresponding to the media asset based on metadata associated with the media asset;
retrieve, from a video frame format database, a video frame template corresponding to the media source;
identify an area within the video frame template that is used for displaying extra information additional to the content of the media asset;
determine whether an information object is displayed at a same area within the respective video frame with the identified area within the video frame template;
in response to determining that the information object is displayed at the same area within the respective video frame with the identified area within the video frame template, perform character recognition on the information object to extract text;
compare the extracted text with metadata associated with the media asset to generate a difference metric;
in response to determining that the difference metric is higher than a difference threshold, determine that the information object within the respective video frame contains extra information additional to content of the media asset.

14. The system of claim 12, wherein the processing circuitry, when querying a spoiler relevance table based on the key term to determine a spoiler metric indicative of a degree of spoiler information that the extra information contains, is further configured to:
transmit a query comprising the key term, to the spoiler relevance table storing a plurality of keywords, each of the plurality of keywords being associated with a numeric value indicating a degree of spoiler relevance that the respective keyword corresponds to;
in response to receiving a matching keyword from the spoiler relevance table identified for the key term, retrieve a first numeric value corresponding to the matching keyword from the spoiler relevance table as the spoiler metric for the extra information; and
in response to receiving no matching keyword from the spoiler relevance table identified for the key term:
obtain a closest keyword from the spoiler relevance table based on the transmitted query;
retrieve a second numeric value corresponding to the closest keyword from the spoiler relevance table as the spoiler metric for the extra information; and
create a new entry in the spoiler relevant table to store the key term corresponding to the second numeric value.

15. The system of claim 12, wherein the processing circuitry, when determining an event relating to the spoiler information based on the spoiler information is further configured to:
transmit, to a data source of data artifacts, a query based on the spoiler information;
in response to the transmitted query, obtain one or more data artifacts containing information that matches the spoiler information; and
parse the one or more obtained data artifacts to identify information of the event relating to the spoiler information, wherein the information of the event is selected from a group consisting of an event name, an event start date, an event end date, an event sponsor name, an event type, an event schedule, an event roster, and a competition result of the event.

16. The system of claim 12, wherein the processing circuitry, when querying of the user activity history based on information relating to the event for a plurality of information artifacts indicative of social media interactions with the event, is further configured to:
access a user profile storing the user activity history including user interactive activities with a plurality of data sources;
determine a query term from the extra information, wherein the query term is indicative of a participant in the event;
query the user activity history based on the query term; and
in response to the query, obtain the plurality of information artifacts containing the query term.

17. The system of claim 12, wherein the processing circuitry, when determining of the blocking metric based on a comparison of the spoiler information relating to the event and the user preference for the event, is further configured to:
for each information artifact from the plurality of information artifacts:
determine a user preference indication for or against the query term based on content of a respective information artifact;
assign a respective cruciality level associated with the query term to each of the plurality of information artifacts based on the user preference indication and the content of the respective information artifact and content; and
compute a normalized sum of all cruciality levels corresponding to the plurality of information artifacts as the block metric.

18. The system of claim 12, wherein the processing circuitry, when generating for display the respective video frame and the extra information with an overlay of a visual element on top of an area where the extra information is displayed to cover the extra information, is further configured to:
determine, from the extra information and by text recognition, a first text displayed at a first area within the respective video frame and a second text at a second area within the respective video frame;
determine that the first text includes the spoiler information and the second text does not include the spoiler information by querying the spoiler relevance table; and
configure size and shape parameters of the visual element to have the visual element cover the first area and to prevent the visual element to cover the second area.

19. The system of claim 12, wherein the processing circuitry, when generating for display of the respective video frame and the extra information with an overlay of a visual element on top of an area where the extra information is displayed to cover the extra information, is further configured to:
retrieve, from a user profile, information relating to one or more user interested items;
query, an advertisement database, based on information relating to the one or more user interested items;
in response to the querying, obtain an advertisement relating to at least one user interested item;
adapt the advertisement into a display advertisement having a size and a shape to cover the extra information; and
overlay the display advertisement on top of the area where the extra information is displayed.

20. The system of claim 12, wherein the processing circuitry is further configured to:
prior to a respective video frame from the plurality of video frames being displayed, receive, via communication circuitry, a user command to launch the overlay of the visual element on top of the area where the extra information is displayed;
in response to the user command, refrain from determining the spoiler metric or the blocking metric; and
generating for display the respective video frame and the extra information with the overlay of the visual element on top of the area where the extra information is displayed to cover the extra information.

21. The system of claim 20, wherein the processing circuitry is further configured to:
in response to receiving the user command:
retrieve a pre-defined white list of alert information that is pre-defined to be exempted from the overlay of the visual element;
determine whether the extra information contained in the respective video frame belongs to the pre-defined white list; and
in response to determining that the extra information contained in the respective video frame belongs to the pre-defined white list, refrain from overlaying the visual element on top of the area where the extra information is displayed for the respective video frame.

22-51. (canceled)
